(19) United States
(12) Patent Application Publication
(10) Pub. No.: US 2014/0366797 A1
(43) Pub. Date: Dec. 18, 2014

(54) PASTE SUPPLY APPARATUS AND SCREEN PRINTING MACHINE

(71) Applicant: Panasonic Corporation, Osaka (JP)

(72) Inventors: Isao HORIE, Yamanashi (JP); Hideki UCHIDA, Yamanashi (JP); Hiroki KOBAYASHI, Yamanashi (JP); Masayuki MANTANI, Yamanashi (JP)

(73) Assignee: Panasonic Corporation, Osaka (JP)

(21) Appl. No.: 14/269,605

(22) Filed: May 5, 2014

(30) Foreign Application Priority Data
Jun. 17, 2013 (JP) 2013-126361

(51) Int. Cl. B05C 11/02

(52) U.S. Cl. CPC B05C 11/02
USPC 118/56; 222/326

(57) ABSTRACT

A paste supply apparatus includes a paste pot including a tubular container which stores paste and which includes a bottom portion provided with a through hole and a movable inner lid provided in the tubular container, and a pot holder which holds the paste pot in a state in which the through hole of the paste pot is directed downward such that lateral expansion of the tubular container is suppressed and downward movement of the tubular container thereof is regulated. The paste supply apparatus further includes a paste ejecting device which presses the inner lid of the paste pot and which ejects the paste in the tubular container from the through hole.

### BACKGROUND

1. Technical Field

An aspect of the present invention relates to a paste supply apparatus for supplying paste to a mask positioned to contact a substrate in a screen printing machine, the screen printing machine, a paste supply method and a screen printing method.

2. Background Art

As a paste supply apparatus for supplying paste to a mask positioned to contact a substrate in a screen printing machine, JP-A-2011-140176 describes an apparatus for ejecting and supplying paste to a mask from a syringe in which the paste is stored. The paste stored in the syringe is provided from a hermetically closed container called a paste pot filled with paste. The paste pot includes a tubular container and an inner lid inserted into the tubular container. JP-A-2010-172928 describes a paste supply apparatus which uses the paste pot itself as a syringe rather than refilling the syringe with paste from the paste pot.

### SUMMARY

As a conceivable structure for using the paste pot itself as a syringe, the paste pot is held such that the through hole formed in a bottom portion of the tubular container is directed downward and downward movement of the tubular container is regulated, and in this state, the inner lid is depressed with respect to the tubular container by a cylinder, whereby the paste stored in the tubular container is ejected from the through hole.

However, when ejection operation of the paste is performed by depressing the inner lid of the paste pot with respect to the tubular container as described above, the whole tubular container is laterally expanded due to internal pressure acting on the tubular container. Consequently, even after depression of the inner lid is stopped, the paste in the tubular container may be ejected due to a force by which the expanded tubular container returns to the original shape. In other words, unintended leakage of the paste may occur, which decreases work efficiency.

An object of an aspect of the invention is to provide a paste supply apparatus and a screen printing machine, which can prevent a delay in work by preventing unintended leakage of paste after a stop of supply of the paste.

In a first aspect, a paste supply apparatus includes: a paste pot which includes a tubular container which stores paste and which includes a bottom portion provided with a through hole and a movable inner lid provided in the tubular container; a pot holder which holds the paste pot in a state in which the through hole of each of the plurality of paste pots is directed downward such that lateral expansion of the tubular container is suppressed and downward movement of the tubular container thereof is regulated; and a paste ejecting device which presses the inner lid of the paste pot with respect to the tubular container and which ejects the paste stored in the tubular container from the through hole.

In a second aspect, a screen printing machine includes: a mask which is positioned to contact a substrate; a paste supply apparatus according to the first aspect, which ejects and supplies the paste to the mask contacting the substrate; and a squeegee slid on the mask to which the paste is supplied by the paste supply apparatus.

According to an aspect of the invention, the paste pot is held in a state in which lateral expansion of the tubular container is suppressed by the pot holder, whereby the tubular container is not expanded laterally in ejection operation of the paste performed by depressing the inner lid of the paste pot with respect to the tubular container. As a result, when depression of the inner lid is stopped, ejection of the paste from the paste pot is also stopped, whereby unintended leakage of paste can be prevented after a stop of supply of the paste. Consequently, a delay in work due to the leakage of paste can be prevented, and work efficiency can be improved.

### BRIEF DESCRIPTION OF THE DRAWINGS

FIG. 1 is a side view of a screen printing machine in one embodiment of the invention;

FIG. 2 is a plan view of the screen printing machine in one embodiment of the invention;

FIG. 3 is a perspective view of a squeegee unit and a paste supply apparatus provided in the screen printing machine in one embodiment of the invention;

FIG. 4A is a perspective view of the paste supply apparatus in one embodiment of the invention, and FIG. 4B is a partially sectional front view of the paste supply apparatus;

FIGS. 5A to 5C are perspective views of a paste pot used in the paste supply apparatus in one embodiment of the invention;

FIGS. 6A and 6B are operation explanatory diagrams of the paste supply apparatus in one embodiment of the invention;

FIG. 7 is a block diagram showing a control system of the screen printing machine in one embodiment of the invention;

FIG. 8 is an operation explanatory diagram of the screen printing machine in one embodiment of the invention; and

FIGS. 9A and 9B are explanatory diagrams of a replacement work procedure of the paste pot of the paste supply apparatus in one embodiment of the invention.

### DETAILED DESCRIPTION

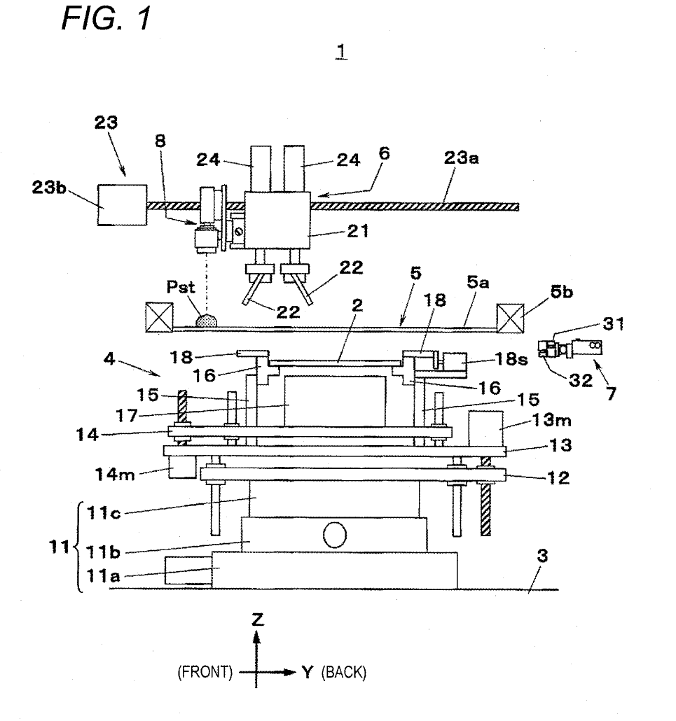

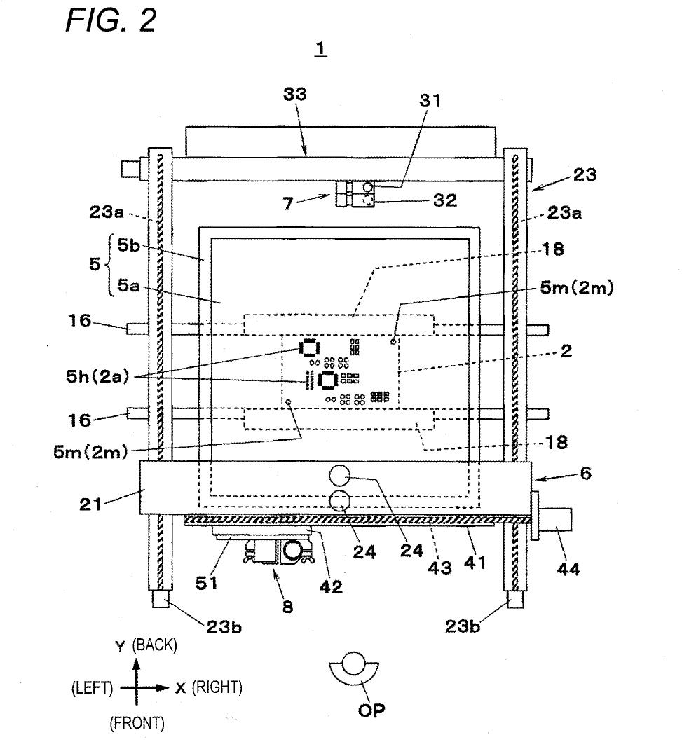

An embodiment of the invention will hereinafter be described with reference to the drawings. A screen printing machine 1 shown in FIGS. 1 and 2 is a machine for repeatedly performing screen printing of paste Pst such as solder paste on a substrate 2. The screen printing machine 1 includes: a substrate holding/moving unit 4 which is provided on a base 3 and which holds and moves the substrate 2; a mask 5 horizontally disposed above the substrate holding/moving unit 4; a squeegee unit 6 provided above the mask 5; a camera unit 7 provided under the mask 5; and a paste supply apparatus 8 provided integrally with the squeegee unit 6 above the mask 5.

As shown in FIG. 1, the substrate holding/moving unit 4 includes: an XYθ movement mechanism 11 provided on the base 3; a base table 12 which is movable on a horizontal plane and rotatable around a vertical axis by the XYθ movement mechanism 11. The substrate holding/moving unit 4 further includes a first lifting table 13 and a second lifting table 14, which are provided on the base table 12 in this order from the downward side.

The XYθ movement mechanism 11 includes a stack of a Y-axis table 11a, an X-axis table 11b and a θ table 11c. The Y-axis table 11a extends in a Y-axis direction (a front-back direction viewed from an operator OP shown in FIG. 2, and the left-right direction in FIG. 1) on the base 3. The X-axis table 11b extends along an X-axis direction (the left-right direction viewed from the operator OP, and the direction orthogonal to the sheet of FIG. 1) on the Y-axis table 11a. The θ table 11c is provided on the X-axis table 11b. The X-axis table 11b is moved on the Y-axis table 11a along the Y-axis direction by driving of the Y-axis table 11a, and the θ table 11c is moved on the X-axis table 11b along the X-axis direction by driving of the X-axis table 11b, and the base table 12 is rotated around vertical axis (Z axis) in FIG. 1 by driving of the θ table 11c. That is, the base table 12 is moved in the horizontal plane by an XYθ movement mechanism 11. The first lifting table 13 is moved upward and downward with respect to the base table 12 by driving of a first lifting table moving motor 13m, and the second lifting table 14 is moved upward and downward with respect to the first lifting table 13 by driving of a second lifting table moving motor 14m.

A pair of conveyor support members 15 is provided to extend upward from the first lifting table 13 and penetrate the second lifting table 14. The pair of conveyor support members 15 supports a pair of conveyors 16 extending in the X-axis direction. The conveyors 16 oppose each other in the Y-axis direction. The pair of conveyors 16 supports both ends of the substrate 2 from the downward side and conveys the substrate 2 in the X-axis direction. On an upper surface of the second lifting table 14, a receiving member 17 is provided.

A pair of clamp members (clampers 18) extending along the Y-axis direction and opposing each other in the X-axis direction is provided on an upper side of the pair of conveyors 16. The pair of clampers 18 is opened and closed in the Y-axis direction by actuation of a clamper open/close cylinder 18s, and grasps and holds (clamps) both ends of the substrate 2 on the conveyors 16.

As shown in FIG. 2, the mask 5 includes: a plate portion 5a with a flat plate shape extending in an XY plane; and a frame-shaped portion 5b for holding the outer periphery of the plate portion 5a. An inside of a rectangular region of the plate portion 5a surrounded by the frame-shaped portion 5b is provided with pattern holes 5h so as to correspond to electrodes 2a formed on the substrate 2.

In FIG. 2, the substrate 2 includes a set of two substrate side marks 2m at diagonal positions thereof, and the plate portion 5a of the mask 5 includes a set of two mask side marks 5m arranged to correspond to the substrate side marks 2m. When the substrate 2 is positioned to contact the mask 5 in a state in which the substrate side marks 2m overlap with the mask side marks 5m in plan view, the electrodes 2a of the substrate 2 become matching with the pattern holes 5h of the mask 5.

In FIGS. 1 to 3, the squeegee unit 6 includes: a squeegee base 21 extending in the X-axis direction; two squeegees 22 which are provided below the squeegee base 21 and arranged to oppose each other in the Y-axis direction; and a squeegee unit moving mechanism 23 which moves the squeegee base 21 in the Y-axis direction. The squeegee unit moving mechanism 23 includes: a pair of squeegee unit moving ball screws 23a which are arranged to oppose each other in the X-axis direction and extend in the Y-axis direction above the mask 5; and two squeegee unit moving motors 23b which rotate and drive the respective squeegee unit moving ball screws 23a. The squeegee unit moving ball screws 23a are respectively screwed through the left and right ends of the squeegee base 21. As a result, when the squeegee unit moving ball screws 23a are rotated forward or backward in synchronization by the two squeegee unit moving motors 23b, the squeegee base 21 is moved along the Y-axis direction according to this rotation. The two squeegees 22 are individually moved upward and downward with respect to the squeegee base 21 by a squeegee moving cylinder 24 formed on the squeegee base 21.

In FIGS. 1 and 2, the camera unit 7 includes: an upward imaging camera 31 with an imaging visual field oriented upward; and a downward imaging camera 32 with an imaging visual field oriented downward. The camera unit 7 is moved in a horizontal plane by a camera unit moving mechanism 33.

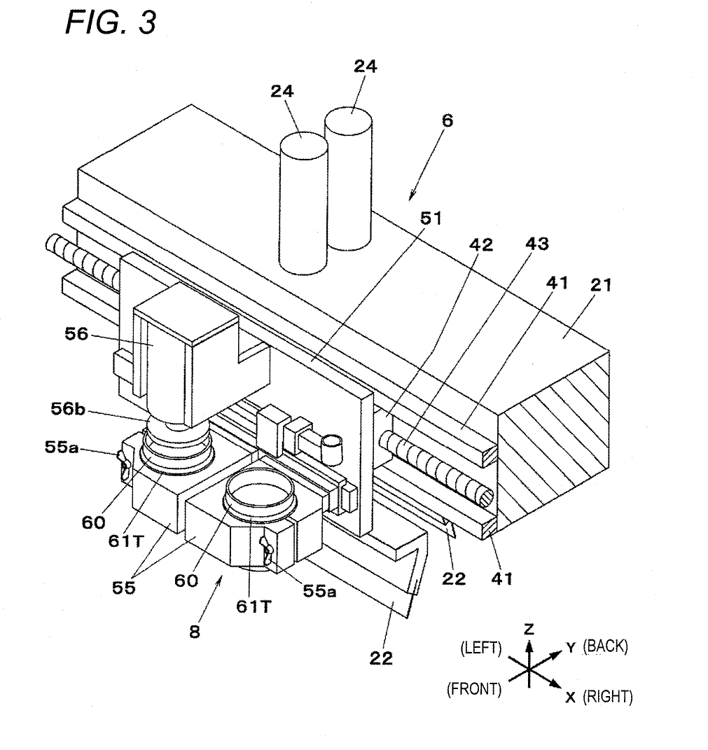

In FIGS. 1 and 2, the paste supply apparatus 8 ejects and supplies the paste Pst to the mask 5 positioned to contact the substrate 2, and is provided on the front side of the squeegee base 21. As shown in FIG. 3, a pair of guide members 41 extending in the X-axis direction is arranged on upper and lower positions in the front of the squeegee base 21, and a ball screw 43 extending in the X-axis direction is screwed through a block member 42 guided to the pair of guide members 41. The ball screw 43 is rotatable by a paste supply apparatus moving motor 44 provided on the end of the squeegee base 21, and the block member 42 is moved in the X-axis direction by forward and backward rotation of the ball screw 43 by the paste supply apparatus moving motor 44.

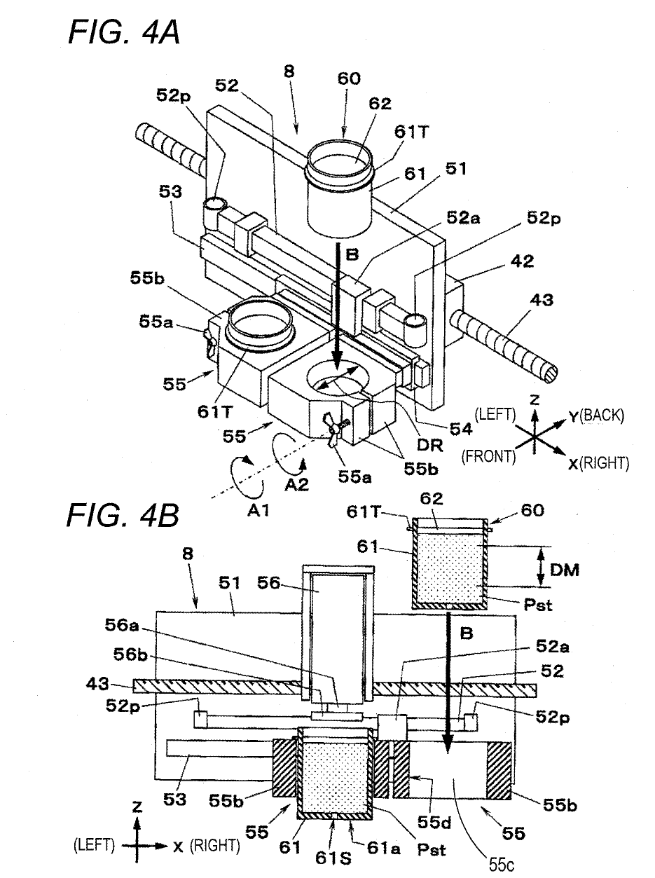

As shown in FIGS. 3, 4A and 4B, the paste supply apparatus 8 includes: a base plate 51 attached to the block member 42 and extending in an XZ plane; a moving cylinder 52 made of, for example, a rod-less cylinder provided on the front of the base plate 51 so as to extend along the X-axis direction; a slider 54 movable on a guide 53 extending along the X-axis direction by the moving cylinder 52; two pot holders 55 arranged along the X-axis direction on the front of the slider 54; and a pressing cylinder 56 fixed to an upper region of the base plate 51.

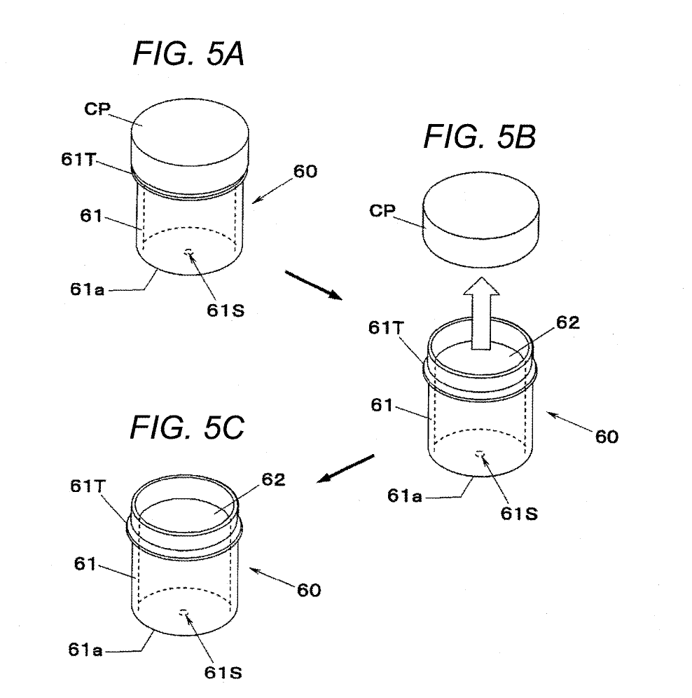

As shown in FIGS. 5A to 5C, a paste pot 60 has an inner lid 62 movably inside a tubular container 61, and receives the paste Pst in the tubular container 61, and includes a through hole 61S in a bottom portion 61a. Before use of the paste pot 60, a cap CP attached to the end of an open side of the tubular container 61 is detached (from FIG. 5A to FIG. 5B), and the paste pot 60 is changed in an attitude in which the through hole 61S is directed downward (FIG. 5C). In this attitude, a brim portion 61T formed around a side surface of the tubular container 61 is in a state positioned in the side upper than a middle portion DM (FIG. 4B) in a vertical direction of the tubular container 61 (FIG. 5C).

As shown in FIGS. 3, 4A and 4B, each of the pot holders 55 has a substantially block shape as a whole. An operator OP screws a wing bolt 55a provided to face to the front (FIG. 4A; arrows A1 and A2), thereby changing a distance between a pair of flange portions 55b into which the wing bolt 55a is screwed. Consequently, an inner diameter DR of a circular hole portion 55c vertically penetrating through the pot holder 55 can be changed.

In order to hold the paste pot 60 in each of the pot holders 55, the operator OP loosens the wing bolt 55a (FIG. 4A; arrow A1), and inserts the paste pot 60 from above into the circular hole portion 55c of the pot holder 55 such that the through hole 61S is directed downward in a state in which the inner diameter DR of the circular hole portion 55c of the pot holder 55 is made larger than an outer shape of a side surface of (i.e., outer diameter of) the paste pot 60 (FIGS. 4A and 4B; arrow B). Then, the wing bolt 55a is tightened (FIG. 4A; arrow A2) such that the brim portion 61T of the tubular container 61 can abut on an upper surface of the pot holder 55 (upper edge of the circular hole portion 55c) from above. Accordingly, the middle portion DM in the vertical direction of the tubular container 61 becomes positioned inside the circular hole portion 55c. Then, the wing bolt 55a is further tightened until a cylindrical inner surface 55d (FIG. 4B) of the circular hole portion 55c of the pot holder 55 makes close contact with the side surface of the tubular container 61, and tightening of the wing bolt 55a is completed.

In the manner described above, the paste pot 60 is attached to the pot holder 55. Accordingly, the brim portion 61T abuts on the upper surface of the pot holder 55, and the side surface of the tubular container 61 makes close contact with the inner surface 55d of the circular hole portion 55c of the pot holder 55. Consequently, downward movement is regulated, and lateral expansion of the tubular container 61 is suppressed by the pot holder 55. That is, in the embodiment, the pot holder 55 is configured to hold the paste pot 60 with the through hole 61S directed downward so as to maintain a state in which lateral expansion of the tubular container 61 is suppressed and downward movement of the tubular container 61 is regulated.

In FIGS. 4A and 4B, the moving cylinder 52 can move a moving body 52a in the left-right direction (X-axis direction) by supplying and draining air to and from left and right ports 52p, thereby moving the slider 54 joined to the moving body 52a so as to perform positional switching in which one of the left and right pot holders 55 is selectively positioned at an ejection position. The ejection position is a position at which the paste Pst stored in the paste pot 60 is ejected. In the embodiment, the ejection position is a position at which the paste Pst can be pressed by the pressing cylinder 56. For example, the ejection position is located below the pressing cylinder 56, and the drawings of the embodiment show the ejection position located immediately below or substantially immediately below the pressing cylinder 56. The ejection position is not limited thereto as long as the paste Pst stored in the paste pot 60 can be ejected by the screen printing machine 1. In addition, the paste pot 60 is attached to and detached from the pot holder 55 in a state in which the pot holder 55 targeted for attachment or detachment of the paste pot 60 is positioned at a position deviating from the ejection position (hereinafter referred to as a pot attaching/detaching position).

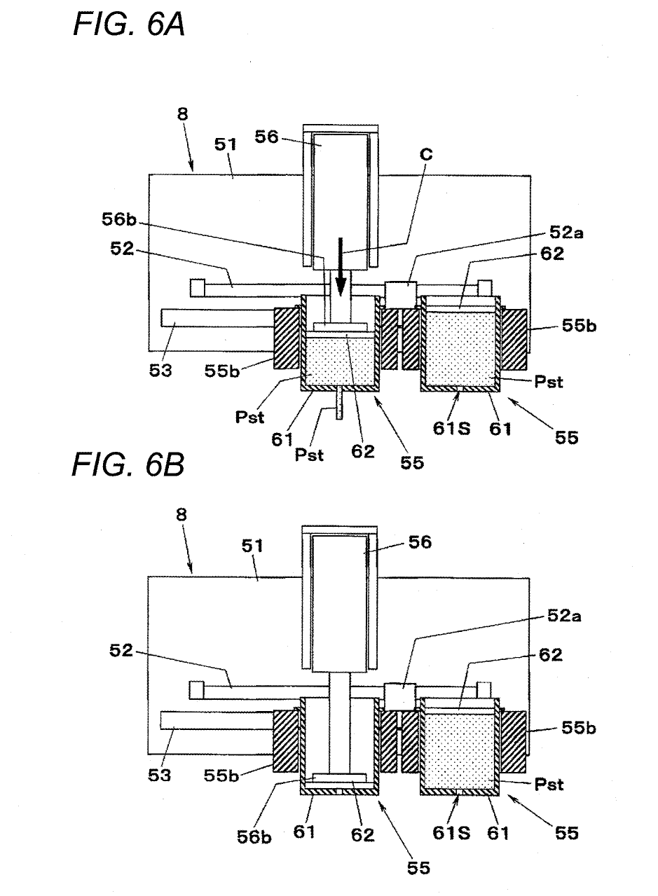

In FIGS. 3, 4A and 4B, the pressing cylinder 56 is attached to the base plate 51 such that with a piston rod 56a is directed downward, and a pad member 56b is attached to a lower end of the piston rod 56a. When the pressing cylinder 56 moves the piston rod 56a downward to protrude, the pad member 56b depresses the inner lid 62 of the paste pot 60 (downward movement of this paste pot 60 is regulated by the pot holder 55 as described above) held in the pot holder 55 positioned at the ejection position with respect to the tubular container 61 (FIG. 6A; arrow C), thereby applying pressure to the paste Pst stored in the tubular container 61 and ejecting the paste Pst downward from the through hole 61S.

In the embodiment, the pressing cylinder 56 serves as an example of a paste ejecting device which presses the inner lid 62 of the paste pot 60 with respect to the tubular container 61 and which ejects the paste Pst stored in the tubular container 61 from the through hole 61S. The ejection of the paste Pst from the paste pot 60 is completed at the time when the inner lid 62 abuts on the bottom portion 61a of the tubular container 61 (FIG. 6B).

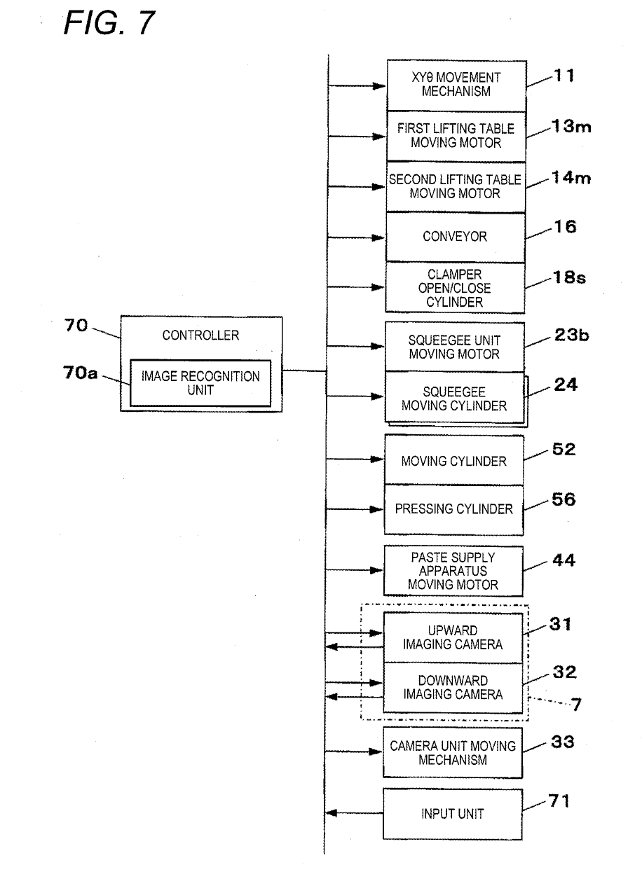

The screen printing machine 1 includes a controller 70. The controller 70 controls: conveyance operation of the substrate 2 in the X-axis direction by the conveyors 16 of the substrate holding/moving unit 4; upward and downward movement operation (support operation of a lower surface of the substrate 2 described below) of the second lifting table 14 by the second lifting table moving motor 14m; substrate clamp operation of the clampers 18 by the clamper open/close cylinder 18s; movement operation of the substrate 2 in the horizontal plane by the XYθ movement mechanism 11; and upward and downward movement operation (upward and downward movement operation of the clamped substrate 2 described below) of the first lifting table 13 by the first lifting table moving motor 13m (FIG. 7). The controller 70 also controls: movement operation of the squeegee unit 6 and the paste supply apparatus 8 along the Y-axis direction by the squeegee unit moving motors 23b; movement operation of the paste supply apparatus 8 along the X-axis direction by the paste supply apparatus moving motor 44; and upward and downward movement operation of each of the squeegees 22 by the squeegee moving cylinder 24 (FIG. 7). The controller 70 also controls: movement operation of the two pot holders 55 along the X-axis direction by the moving cylinder 52; and ejection operation of the paste Pst from the paste pot 60 by the pressing cylinder 56 (FIG. 7).

The controller 70 controls movement operation of the camera unit 7 in the horizontal plane by the camera unit moving mechanism 33; imaging operation of the upward imaging camera 31 provided in the camera unit 7; and imaging operation of the downward imaging camera 32 provided in the camera unit 7 (FIG. 7). The image data obtained by the imaging operation of the upward imaging camera 31 and the image data the imaging operation of the downward imaging camera 32 are inputted to the controller 70, and image recognition processing is performed in an image recognition unit 70a (FIG. 7).

Next, an execution procedure (screen printing method) of screen printing work by the screen printing machine 1 will be described. In this procedure, at first, the operator OP operates an input unit 71 (FIG. 7) connected to the controller 70 for starting a predetermined screen printing work. On receiving the input for starting the screen printing work, the controller 70 receives and conveys the substrate 2 loaded from the outside of the screen printing machine 1 by the conveyors 16, and positions the substrate 2 at a work position of below a space between the pair of clampers 18. After the second lifting table 14 is moved upward with respect to the first lifting table 13 and a lower surface of the substrate 2 is supported by the receiving member 17, the second lifting table 14 is moved further upward and the substrate 2 is lifted from the conveyors 16, and both ends of the substrate 2 are clamped and held from the Y-axis direction by a pair of clampers 18.

After the substrate 2 is clamped, the controller 70 moves the camera unit 7 to enter a space under the mask 5. The camera unit 7 images the substrate side marks 2m provided on the substrate 2 from above the substrate 2 by the downward imaging camera 32, thereby obtaining image data of the substrate side marks 2m. The camera unit 7 also images the mask side marks 5m provided on the mask 5 from below the mask 5 by the upward imaging camera 31, thereby obtaining image data of the mask side marks 5m. Then, image recognition based on the obtained image data of the substrate side marks 2m is performed to calculate a position of the substrate 2, and image recognition based on the image data of the mask side marks 5m is performed to calculate a position of the mask 5.

After the position of the substrate 2 and the position of the mask 5 are calculated, the controller 70 moves the camera unit 7 at a position deviating from the space under the mask 5. Then, actuation control of the XYθ movement mechanism 11 is performed to move the substrate 2 so as to position the substrate side marks 2m under (e.g., just under) the mask side marks 5m. Accordingly, the positioning of the substrate 2 is performed with respect to the mask 5.

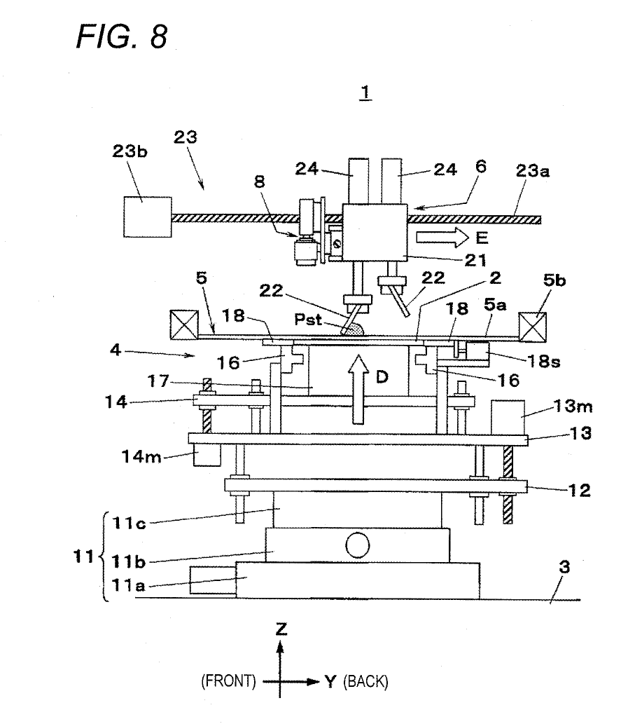

After the substrate 2 is positioned with respect to the mask 5, the controller 70 moves the first lifting table 13 of the substrate holding/moving unit 4 upward with respect to the base table 12 (FIG. 8; arrow D). Accordingly, the electrodes 2a of the substrate 2 match with the pattern holes 5h of the mask 5, and an upper surface of the substrate 2 and upper surfaces of the clampers 18 are positioned to contact a lower surface of the mask 5 (a contact step).

After the substrate 2 is positioned to contact the mask 5, the controller 70 moves the squeegee base 21 in the Y-axis direction, and also moves the paste supply apparatus 8 at a given or predetermined position (normally, a position above a portion of the mask which contacts the front clamper 18). Then, the paste supply apparatus moving motor 44 is actuated so as to move the paste supply apparatus 8 in the X-axis direction, and also the pressing cylinder 56 is actuated, whereby the paste Pst is ejected from the through hole 61S of the paste pot 60, and the paste Pst is supplied to the mask 5 (a paste supply step).

In the paste supply step, the tubular container 61 of the paste pot 60 is held in a state in which the lateral expansion is suppressed by the pot holder 55 as described above, whereby the tubular container 61 is not expanded laterally during ejection operation of the paste Pst performed by depressing the inner lid 62 of the paste pot 60 with respect to the tubular container 61. As a result, when depression of the inner lid 62 is stopped, ejection of the paste Pst from the paste pot 60 is also stopped, and after a stop of supply of the paste Pst, unintended leakage of paste Pst does not occur.

After the paste Pst is supplied to the mask 5, the controller 70 moves one squeegee 22 downward with respect to the squeegee base 21 so as to abut the lower end of the squeegee 22 on the mask 5, and moves the squeegee base 21 in the Y-axis direction (FIG. 8; arrow E), whereby the squeegee 22 is slid on the mask 5 (a squeegee sliding step). Accordingly, the paste Pst supplied to the mask 5 by the paste supply step is scraped by the squeegee 22, and the paste Pst is transferred to the electrodes 2a of the substrate 2 through the pattern holes 5h of the mask 5.

When the paste Pst is transferred, the controller 70 abuts the front squeegee 22 (left side of paper of FIG. 8) on the mask 5 when the squeegee base 21 is moved from the front to the back of the screen printing machine 1 (from the left to the right in FIG. 8), and abuts the back squeegee 22 (right side of paper of FIG. 8) on the mask 5 when the squeegee base 21 is moved from the back to the front of the screen printing machine 1 (from the right to the left in FIG. 8).

After the transfer work of the paste Pst is completed, the controller 70 moves the first lifting table 13 downward so as to separate the substrate 2 from the mask 5. Further, holding (clamping) of the substrate 2 by a pair of clampers 18 is released, and thereafter, the second lifting table 14 is moved downward and the substrate 2 is lowered on the conveyors 16. Then, the conveyors 16 are actuated to carry the substrate 2 to the outside of the screen printing machine 1. Accordingly, the screen printing work per sheet of the substrate 2 is completed.

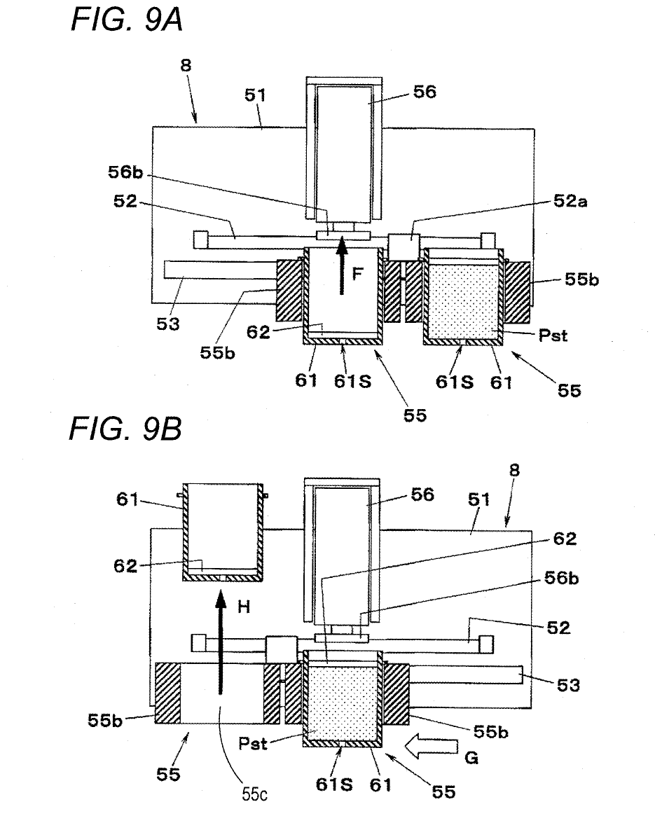

In order to replace an empty paste pot 60 with a new paste pot 60 in the paste supply step of the screen printing work, the operator OP performs a predetermined operation through the input unit 71, whereby the controller 70 actuates the pressing cylinder 56 and positions the pad member 56b above the paste pot 60 (FIG. 9A; arrow F) and then, actuates the moving cylinder 52 and performs positional switching of the pot holder 55. Accordingly, since the pot holder 55 having existed at the ejection position is positioned at the pot attaching/detaching position and the pot holder 55 having existed at the pot attaching/detaching position is positioned at the ejection position, the empty paste pot 60 is moved to the pot attaching/detaching position and the new paste pot 60 having existed at a standby state is moved to the ejection position (FIG. 9B; arrow G).

After the positional switching of the pot holder 55 is performed as described above, the operator OP loosens the wing bolt 55a of the pot holder 55 positioned at the pot attaching/detaching position, and pulls up the empty paste pot 60 upward from the circular hole portion 55c while increasing the inner diameter of the circular hole portion 55c of the pot holder 55 (FIG. 9B; arrow H). Then, a new paste pot 60 is attached to the pot holder 55 from which the empty paste pot 60 has been pulled out, and the wing bolt 55a is tightened, whereby the new paste pot 60 is held in the pot holder 55. The paste pot 60 is, for example, a disposable consumable part as a whole, and the empty paste pot 60 detached from the pot holder 55 is discarded as it is.

In the paste supply apparatus 8 (the screen printing machine 1) according to the above-described embodiment, the paste pot 60 is held in a state in which lateral expansion of the tubular container 61 is suppressed by the pot holder 55, so that the tubular container 61 is not expanded laterally in the ejection operation of the paste Pst performed by depressing the inner lid 62 of the paste pot 60 with respect to the tubular container 61. As a result, when depression of the inner lid 62 is stopped, ejection of the paste Pst from the paste pot 60 is also stopped. Further, after a stop of supply of the paste Pst, unintended leakage of paste Pst can be prevented. Consequently, it is possible to prevent a delay in work due to the leakage of paste Pst, thereby to improve work efficiency.

As described above, the embodiment of the invention provides a paste supply apparatus and a screen printing machine, which can prevent a delay in work by preventing unintended leakage of paste after stop of supply of the paste.

Although the invention has been described in detail with reference to specific embodiments, various changes or modifications may be made without departing from the spirit and scope of the invention.

This application is based on Japanese Patent Application No. 2013-126361, filed Jun. 17, 2013, the entire contents of which are incorporated herein by reference.

What is claimed is:

1. A paste supply apparatus comprising:
a paste pot which comprises a tubular container which stores paste and which comprises a bottom portion provided with a through hole and a movable inner lid provided in the tubular container;
a pot holder which holds the paste pot in a state in which the through hole of the paste pot is directed downward such that lateral expansion of the tubular container is suppressed and downward movement of the tubular container thereof is regulated; and
a paste ejecting device which presses the inner lid of the paste pot with respect to the tubular container and which ejects the paste stored in the tubular container from the through hole.

2. A screen printing machine comprising:
a mask which is positioned to contact a substrate;
a paste supply apparatus according to claim 1, which ejects and supplies the paste to the mask contacting the substrate; and
a squeegee slid on the mask to which the paste is supplied by the paste supply apparatus.
